(19) United States
(12) Patent Application Publication
(10) Pub. No.: US 2013/0076090 A1
(43) Pub. Date: Mar. 28, 2013

(54) VIBRATION CONVERTING CHAIR

(71) Applicant: Tae Gyun Kim, Seongnam-si (KR)

(72) Inventor: Tae Gyun Kim, Seongnam-si (KR)

(21) Appl. No.: 13/701,547

(22) PCT Filed: Jun. 10, 2011
(86) PCT No.: PCT/KR11/04268

§ 371 Date: Dec. 3, 2012

(30) Foreign Application Priority Data
Jun. 25, 2010 (KR) 10-2010-0060343

(51) Int. Cl. A47C 7/72; B06B 1/02

(52) U.S. Cl. CPC A47C 7/72; B06B 1/02
USPC 297/217.4; 367/189

(57) ABSTRACT

Disclosed is a vibration converting chair to be able to most effectively transmit the vibration energy of a transducer by molding a spring material in all-in-one form within a foam sponge which is a material of a cushion or a back piece of a chair and by implementing a new type of vibration transmission method to fix a transducer, which converts acoustic signals into vibrations, on the spring material within the foam sponge in a free condition, and therefore, for a sitter to be able to experience more detailed three-dimensional vibrations, and on the other hand, to be enable to enhance the durability of the foam sponge with the pressure dispersed by combining the spring and the mesh materials molded within the foam sponge in all-in-one form, and eventually to be able to improve the effects of experiencing the vibrations by maximally spreading the vibrations.

### FIELD OF THE INVENTION

The present invention relates to a vibration converting chair. More particularly, a chair with a transducer which converts acoustic signals to vibrations is equipped on the back piece or the cushion of a chair so that the body of a sitter can directly experience the vibrations generated from the signals.

### BACKGROUND OF THE INVENTION

In general, a human sees three-dimensional stereoscopic images, but when a image taken by a camera or camcorder is displayed on TVs, monitors or theater's screens, the image becomes flat two-dimensional, which leads to a significant decrease of the three-dimensional effects.

Considering this, tangible chairs equipped with a device for special effects have been suggested recently for theaters, event halls of amusement parks or three-dimensional theaters so that various situations can indirectly be experienced.

Taking opportunities of the proliferation of digital media with bi-directional communication function and the restoration of the film industry, in recent years, the new market potential for new types of film industry is cautiously emerging.

By use of three-dimensional recording equipment when shooting a movie, two-dimensional as well as more realistic three-dimensional movies with the same contents may be released at the same time. Specialized three-dimensional theaters for their presentation and theaters which adopt vibration converting chairs with an auto-vibrating device in conjunction with mid- and low-pitched sound in the film are emerging so that moviegoers can experience the more profound sounds.

Most of these vibration converting chairs adopt the method which converts electrical sound signals into mechanical vibrations and passes them to the body of a sitter.

But the conventional vibration converting chairs have had a limit in passing small vibrations by use of mechanical vibration method. And also there are many problems such as discomfort feelings by the mechanical power, the rising cost of production and the complexity of the device.

Accordingly, it is a recent trend to make an effort and a study, from an different angle, on the method to afford moviegoers to experience uniqueness and varieties different from traditional approaches, and to provide similar environment effect with the film contents to moviegoers so that they can watch the movie with more fun and so that they can immerse themselves in the movie.

### EXPLANATION OF THE INVENTION

### Problems which the Invention Aims to Solve

Therefore, the purpose of the present invention by considering those problems is to provide a vibration converting chair which allows a user to experience more elaborate and three-dimensional vibrations and which can most effectively pass the transmission energy of a transducer to convert acoustic signals into vibrations by installing a single-piece spring member within a sponge foam in a cushion or back piece where the transducer is fixed on the spring member in its free condition, which is a new type of vibration transmission method.

In addition, another purpose of the present invention is to provide a vibration converting chair able to increase the effects of vibration experience by combining a single-piece spring on a foam sponge with a mesh-type material, which increases the durability of the foam sponge and maximizes the distribution of the vibration.

Also, another purpose of the present invention is to provide a vibration converting chair able to increase the functionality and usefulness of a vibration chair by appropriately setting the density of a foam sponge, the spacing and diameter of a spring and mesh to pass the vibrations of a transducer, which increases the vibration transmission characteristics by allowing it to adjust the resonant frequency to meet the desired characteristics.

Furthermore, the other purpose of the present invention is to provide a vibration converting module able to be used for various purposes such as chairs for home or theaters as well as other furniture by implementing a form of the assembly combined a transducer with a single piece that a spring-type or mesh-type material and a foam sponge is made into.

### Disclosure of the Invention

### Means of Solving the Problems

To achieve the above purposes, the present invention includes, in combination, a vibration converting chair including a foam sponge which makes a chair body, a spring for passing vibrations, a transducer for converting sound signals into vibrations: the spring with the platy form bent in several times that is integrated and supported in the foam sponge, and the transducer that is placed in the groove of the backside of the spring and that is clamped and fixed on the front-side transducer bracket of the spring with screws. The present invention is characterized by a structure able to effectively transmit the vibration energy of the transducer by using the free supporting structure of the spring.

Here, it is desirable that the vibration converting chair is made to increase the durability of the sponge by distributing the pressure on the sponge and to maximally pass the distributed vibrations through the overall mesh by placing the one side of the spring over the mesh with which the spring is integrated into a single piece in the foam sponge.

On the other side to achieve the above purposes, a vibration converting module in the present invention includes: a foam sponge in a form of block with a groove for transducer on one side, a spring enable to pass the vibration in the single-piece foam sponge, a transducer bracket located on the front side of the spring and clamped with screws for fixing the transducer in the single-piece foam sponge, a transducer located in a backside groove for transducer and clamped with the screws for fixing transducer on the transducer bracket located on the front-side of the spring, and a mesh located over the one surface of the spring and integrated with the foam sponge to disperse the pressure on the sponge and the vibrations being passed from the transducer. The module is characterized by this structure for various purposes including theater chairs.

### Advantageous Effect of the Invention

A vibration converting chair of the present invention provides the advantages as follows:

Firstly, by the fact that the spring to pass the vibrations of the transducer is not fixed on the frame as usual but integrated with the sponge assuring the supporting structure in a free condition, the spring can most effectively transmit the vibration energy of the transducer and therefore the user can experience more detailed three-dimensional vibrations.

Secondly, by combining the spring and the mesh in the foam sponge, the distribution of the pressure increases the durability of the foam sponge and improves the effects of the vibrations.

Thirdly, by setting the gap and diameter of the spring and the density of the foam sponge to optimal conditions, the resonant frequency of the transducer is adjustable to the characteristics the user wants and therefore, the functionality and effectiveness of the vibration converting chair can be improved.

Lastly, by manufacturing a foam sponge, a sponge and mesh, and a transducer into a single assembly module, the module can be utilized for theater chairs, home chairs and other furniture.

### BRIEF DESCRIPTION OF THE DRAWINGS

FIG. 1 illustrates an oblique side view of a preferred embodiment which shows a combination form of a foam sponge, a spring, a mesh and a transducer in a vibration converting chair of the present invention;

FIG. 2 shows a top view of the combination form of the foam sponge, the spring, the mesh and the transducer in a vibration converting chair of the present invention;

FIG. 3 shows a side-cut view of the combination form of the foam sponge, the spring, the mesh and the transducer in a vibration converting chair of the present invention;

FIG. 4 shows a front and top view of a mold which integrates a foam sponge, a spring, a mesh and a transducer bracket to a single-piece in a vibration converting chair of the present invention;

FIG. 5 illustrates an oblique front view of a preferred embodiment which shows a combination form of a foam sponge, a spring, a mesh and a transducer in a vibration converting chair of the present invention; and,

FIG. 6 illustrates an oblique side view of a preferred embodiment which shows a combination form of a foam sponge, a spring, a mesh and a transducer in a vibration converting chair of the present invention.

### DETAILED DESCRIPTION OF THE PRESENT INVENTION

Hereinafter, with reference to the accompanying drawings, detailed description is explained as follows:

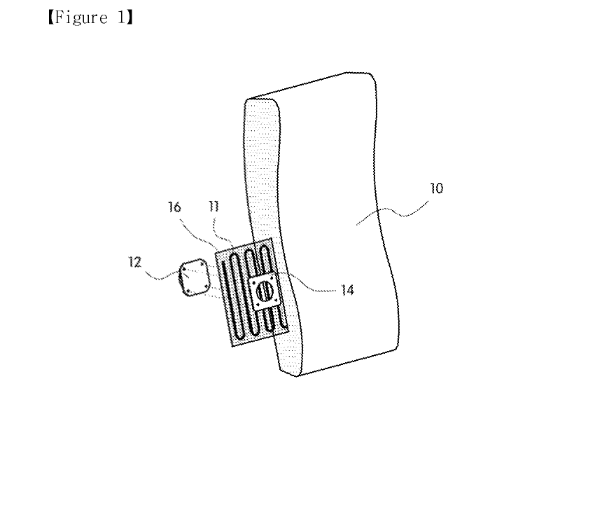

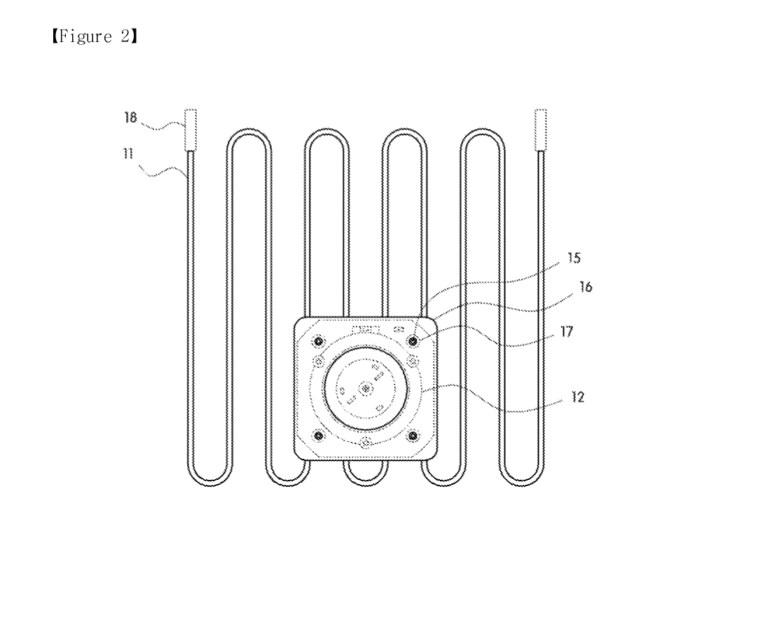

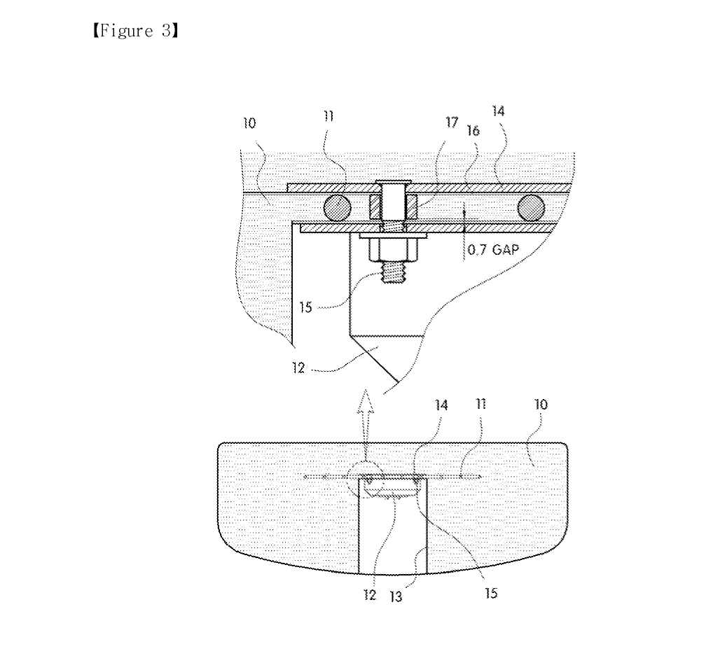

FIG. 1, FIG. 2 and FIG. 3 illustrates an oblique side view, front view and side-cut view, respectively of a preferred embodiment which shows a combination form of a foam sponge, a spring, a mesh and a transducer in a vibration converting chair of the present invention.

As shown in FIG. 1, FIG. 2, and FIG. 3, the vibration converting chair has the structure that the spring (11) passing the vibrations of the transducer is not fixed on the chair frame but integrated within the foam sponge (10) in a single-piece. Through the structure of the spring (11) in a free condition the vibration energy of the transducer (12) can most effectively be passed.

For example, in previous conventional cases, the spring (11) is fixed on the rigid body like the chair frame, so when the magnet in the transducer (12) vibrates there exists the vulnerability that the vibrations is weakly passed, depending on the magnet tremors only due to the fact that the cover body of the transducer (12) is fixed on the spring (11) trapped by the rigid frame.

However, in the case of the present invention, the cover body of the transducer (12) is fixed on the spring (11) in a free condition with the spring which is fixed on the foam spring (11), so the magnet of the transducer as well as the whole cover body tremble together with the spring (11), and as a result the vibration energy of the transducer (12) can more effectively be passed.

For this purpose, a foam sponge (10) with the prescribed form of a rectangular block like a cushion or back piece shape of a chair and a spring (11) passing the vibrations, trembling together with the transducer (12) during the operation of the transducer (12), are prepared.

Here, the one side of the prescribed foam sponge (10) like the back side of it provides an approximately rectangular groove for transducer (13), so the transducer (12) can be installed within it.

In this case, the prescribed spring (11) in a form of zigzag platy shape bent several times can be located on the whole area or a part of the foam sponge (10).

In particular, the prescribed spring (11) is integrally molded within the supporting structure of the foam sponge (10) in a single piece.

In other words, when molding the foam sponge (10) the prescribed spring (11) is inserted and molded together in a mold (not shown here), so the spring (11) and the foam sponge (10) is able to achieve an integration, and eventually the spring (11) is not supported by other separate structures but the spring (11) has its own structure in a free condition within the foam sponge (10).

Like this, with the spring (11) supported in a free condition the spring (11) can most effectively pass the vibration energy of the transducer (12).

And, in the sharp end edge of the spring (11) integrated within the prescribed foam sponge (10) a certain length of plastic tube (18) is equipped with, and therefore in spite of the influence of long-term use by the load the end of the spring will be able to prevent segregation from the sponge.

Here, in the case of the prescribed spring (11) taking into account the resonant frequency of the foam sponge, it is desirable for the spring gap (the space between two spring wire lines located in parallel relative to the bent points) to be set to 23˜33 mm, for the spring diameter to be set to 3˜4.5 mm, and for the density of the foam sponge (12) to be set to 60˜70 kg/m³ in consideration of the bond strength and vibration transmission characteristics of the spring (11).

Like this, the resonant frequency is adjustable by changing the gap and diameter of the prescribed spring (11), and thereby it is possible to manufacture the spring that satisfies the desired characteristics by suitably choosing the gap and the diameter of the spring.

In addition, the present invention provides the mesh (16), composed in the form of soft straight hair (in the form of lattice network), to widely spread the vibration energy of the transducer (12) and to disperse the load of the sitter acting on the sponge.

The prescribed mesh (16) is installed in a structure integrated within the foam sponge (10) over the whole spring area from the one side of the spring (11), for example, the front side.

In other words, the mesh (16) and the spring (11) are inserted and molded together in a single piece during molding the foam sponge (10).

Here, it is desirable to use the petroleum-based adhesive materials able to be well bonded with the sponge for the prescribed mesh (16).

Accordingly the mesh (16) can be located over the whole area of the spring (11), and the tremors passed to the spring (11) can be distributed over the whole mesh (16), and ultimately the distribution of the vibration can be maximized.

Also, with the prolonged use of the prescribed spring (11) only, segregation of it from the sponge may occur. Locating the mesh (16) around the spring (11) as the above can spread the pressure, and eventually increase the durability of the foam sponge (10).

And, the prescribed mesh (16) inserted and located between the spring (11) and a transducer bracket (14) which is described later can play an role of preventing abnormal noises between the spring and the bracket.

As a means of securing the prescribed transducer (12) a transducer bracket (14) in a rectangular plate shape is arranged. The transducer bracket (14) in this case is placed on the front side of the spring (11) and can be clamped and fixed with screws (15) between the spring (11) and the producer (12) which is placed on the back side.

The transducer bracket (14) can be inserted and integrally molded together with the spring (11) and the mesh (16) in the mold during molding the foam spring (10).

In other words, with the spring (11) adopted in the structure the spring (11) and the transducer bracket (14) may be directly encountered, or with the spring (11) and the mesh (16) adopted together in the structure the spring (11), the mesh (16) and the transducer bracket (14) may be placed in parallel within the foam sponge (10).

Also, screws (15) as a means of clamping the transducer on the prescribed transducer bracket (14) are in a form of integration with the bracket which can be inserted for welding on the transducer (14). So the clamping work for installing the transducer (12) may be more easily performed without any additional work for clamping a separate bolt and nut.

In other words, inserting the four male screws (15), protruded toward the backside of the spring (11) in the constant length, into the hole of the transducer (12) and clamping them with the female screw may be more easily done.

In addition, a transducer-mounting spacer (17), which is interposed when clamping the transducer (12) and the transducer bracket (14) is provided in the present invention.

The prescribed transducer-mounting spacer (17) is interposed in a state inserted into the screw (14) between the transducer bracket (14) and the transducer (12). The thickness of the transducer spacer (17) is relatively smaller than the diameter of the spring (11), so the gap between the transducer-mounting spacer (17) and the inside of the transducer (12) will be created.

As an example, the gap of the difference will be achieved by taking the transducer-mounting spacer (17) which is 0.2˜0.4 mm smaller than the diameter of the spring.

Accordingly, when tightening the transducer (12), the plate of the transducer (12) (the plate for clamping around the border of the transducer body) will be pushed and clamped as much as the gap (slightly warped towards the spacer). This will enhance the binding power between the transducer (12) and the spring (11) and prevent screw loosening.

On the other hand, a vibration converting module composed of a foam sponge (10), a spring (11), a mesh (16) and a transducer (12) in a form of assembly is provided in the present invention.

For example, a foam sponge (10) in a form of block with a groove for transducer (13) is prepared; a mesh (16) integrally composed of a platy bent spring (11) and a lattice single-plate is arranged in turn; and an all-in-one type transducer bracket (14), to secure the transducer (12) within the foam sponge (10), is placed on the front side of the spring (11).

Like this, all-in-one type vibration converting module composed of the foam sponge (10), the spring (11), the mesh (16) and the transducer (12) is completed by clamping the transducer (12) with screws (15) protruded from the transducer bracket through the mesh (16) and the spring (11) within the groove for transducer (13),

Of course, the transducer-mounting spacer can be embedded in the inside of the prescribed transducer (12) clamped with the screw (15).

Thus, such a single form of vibration converting module provides advantages able to be widely utilized in theater chairs as well as home chairs, sofas, other furniture and products which require sound effects and vibration effects at the same time.

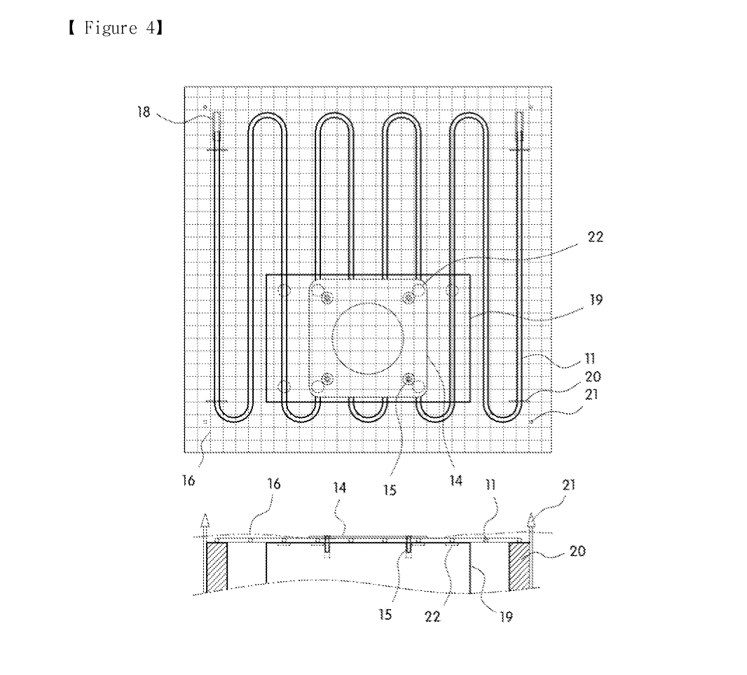

FIG. 4 shows a front and top view of the mold which integrates a foam sponge, a spring, a mesh and a transducer bracket to a single-piece in a preferred embodiment.

As shown in FIG. 4, a core mold (19) for molding a groove for transducer (13) and several spring supports (20) are arranged within the inside of the mold, and mesh pins (21) are arranged in the four corners.

A platy spring (11) will be placed on the prescribed spring supports (20), and on it a mesh (16) and a transducer bracket (14) will be placed in turn.

The mesh (16) is fixed on four places with the mesh pins (21), and the prescribed transducer bracket (14) becomes in a state being with screws (15).

In particular, the prescribed core mold (19) is provided with about eight magnets (22) for tightening the spring on the places where the spring (11) is passing, and the magnets (22) are equipped in a structure 0.2˜0.4 mm long protruded from the surface of the mold.

As shown above, after the arrangement of the spring (11), the mesh (16) and the transducer bracket (14) are completed within the mold, resin injection is carried out with the mold covered together. This produces all-in-one type assembly of the foam sponge, the spring, the mesh and the transducer bracket. After the work, only assembling a transducer (12) can lead to a completion of a vibration converting module, or a cushion or a back piece of a vibration converting chair.

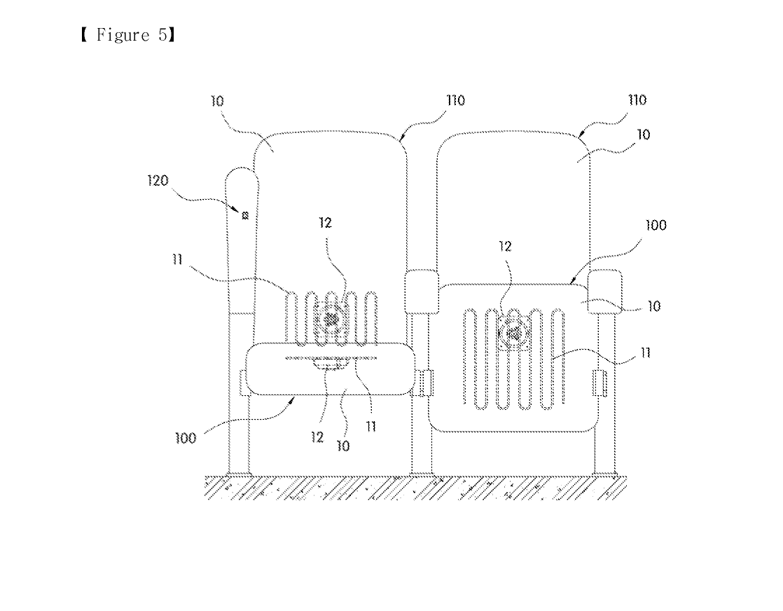

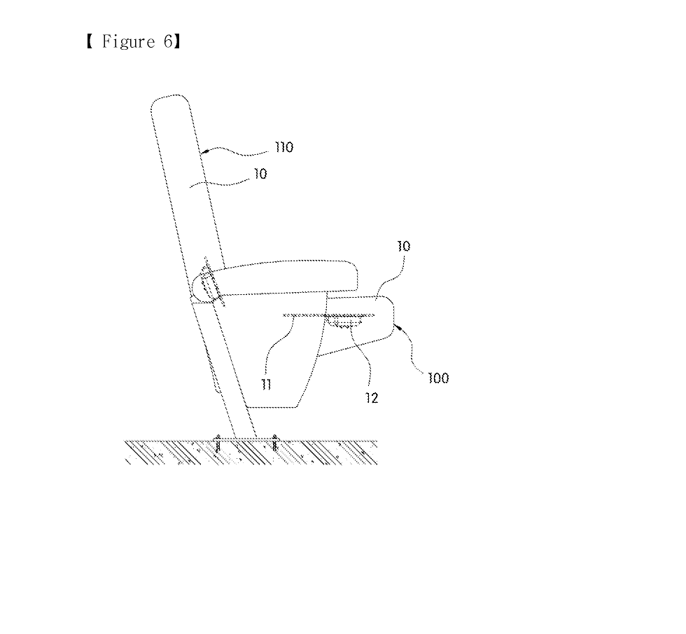

FIG. 5 and FIG. 6 illustrate an oblique front view and side view respectively of a preferred embodiment which shows a combination form of a foam sponge, a spring, a mesh and a transducer in a vibration converting chair of the present invention.

As shown in FIG. 5 and FIG. 6, they show vibration converting chairs being used in theaters.

A cushion of the vibration converting chair (100) is equipped with an all-in-one type foam sponge with a transducer (12), a mesh (not shown here) and a spring (11) over the whole area, and a back piece is equipped with an all-in-one type foam sponge with a transducer (12), a mesh (not shown here) and a spring (11) over a part of the area of the back.

Here, unexplained mark 120 represents an on/off switch for vibration.

Thus, vibrations of the transducer (12) in connection with the sound from the movie is passed through the spring (11) and the foam sponge (10) with the supporting structure in a free condition to the body of a sitter, and the vibrations are dispersed and passed wholly by the mesh, so the sitter can experience more detailed three-dimensional effects of vibration of deep feeling.

### DEFINITION OF MARKS

| | | | |
|---|---|---|---|
| 10 | foam sponge | 11 | spring |
| 12 | transducer | 13 | groove for transducer |
| 14 | transducer bracket | 15 | screw |
| 16 | mesh | 17 | transducer-mounting spacer |
| 18 | plastic tube | 19 | core mold |
| 20 | spring support | 21 | mesh pin |
| 22 | magnet | | |

1. A vibration converting chair, characterized by the structure able to effectively transmit the vibration energy of a transducer by using the free supporting structure of a spring, which comprises a foam sponge which constructs a chair body, a spring for transmitting vibrations, and a transducer which converts sound signals into vibrations:
said spring in a platy form bent several times, supported by all-in-one within a foam sponge; and,
said transducer arranged in a groove for transducer in the back side of said spring, structured by being clamped and fixed with screws on a transducer bracket which is arranged on the front side of said spring.

2. A vibration converting chair of claim 1, wherein a mesh which disperses the pressure on said sponge and spreads vibrations passing from said transducer is arranged on one side of said spring over the whole area of said spring in all-in-one form within said foam sponge.

3. A vibration converting chair of claim 1, wherein a transducer-mounting spacer is interposed between a transducer bracket and said transducer which is clamped to said transducer bracket with said spring placed in-between, and said transducer-mounting spacer is relatively smaller than the diameter of said spring so that adhesion between said transducer and said spring can be improved by a gap being created between said transducer-mounting spacer and said transducer.

4. A vibration converting chair of claim 1, wherein said screws for clamping said transducer is prepared on said transducer bracket in all-in-one type so that the work for installing said transducer can be made easy.

5. A vibration converting chair of claim 1, wherein the end of said spring molded on said foam sponge in all-in-one type is equipped with a plastic tube to prevent segregation of said sponge.

6. A vibration converting chair of claim 1, wherein the gap and the diameter of said spring are 23˜33 mm and 3˜4.5 mm respectively and the density of said foam sponge is set to 60˜70 kg/m³.

7. A vibration converting module comprising:
a) a foam sponge in a block form with a groove for transducer;
b) a spring for transmitting vibrations;
c) a transducer, which converts sound signals into vibrations, to be arranged within a groove for transducer at the back side of said spring and to be clamped and fixed with screws on a transducer bracket which is arranged on the front side of said spring; and
d) a transducer bracket, to fix said transducer with it molded and supported in all-in-one form within said foam sponge, to be clamped and fixed with screws and said transducer which is arranged on the front side of said spring.

8. A vibration converting chair of claim 7, further comprises: a mesh to be arranged on the one side of said spring over the whole area of said spring, to be arranged within said foam sponge in all-in-one form, to disperse the pressure on said sponge and to spread the vibrations transmitted from said transducer.
